(19) United States
(12) Patent Application Publication
(10) Pub. No.: US 2009/0006744 A1
(43) Pub. Date: Jan. 1, 2009

(54) Automated intermittent data mirroring volumes

(76) Inventors: Joseph S. Cavallo, Waltham, MA (US); Brian Leete, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/823,834

(22) Filed: Jun. 28, 2007

(51) Int. Cl. G06F 12/02

(52) U.S. Cl. 711/114

(57) ABSTRACT

Methods and apparatus relating to automated intermittent data mirroring volumes are described. In one embodiment, data mirroring may be suspended in response to occurrence of a scheduled or predefined event. Other embodiments are also disclosed.

### BACKGROUND

The present disclosure generally relates to the field of electronics. More particularly, an embodiment of the invention generally relates to automated intermittent data mirroring volumes.

In data storage, data mirroring may be used to replicate data on more than one storage disk. For example, a Redundant Array of Independent Drives (or Disks), also known as Redundant Array of Inexpensive Drives (or Disks) (RAID) level 1 (or RAID-1) may be used for fault tolerance resulting from disk errors.

Generally, RAID-1 volumes constantly mirror their data, typically to two different disk drive spindles. Once data mirroring is broken, it may not be resumed until an entire disk drive to disk drive copy for broken mirror is performed.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 2 illustrate block diagrams of disk mirroring systems, according to some embodiments.

FIG. 3 illustrates a flow diagram of a method according to an embodiment.

FIG. 4 illustrates a block diagram of an embodiment of a computing system, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may enable automated intermittent mirroring (which may be generally referred to herein as “AIM”). For example, in response to occurrence of an event (which may be a predefined type of an event, a scheduled event, etc.), data mirroring may be automatically suspended and/or resumed. Such implementations may result in power savings, e.g., by reducing power consumption of inactive disk drives. Furthermore, as discussed herein, the term “volume” may generally refer to a logical storage volume that may correspond to a set of mirrored disks (e.g., two or more disks). Also, even though some embodiments discussed herein may refer to various disks that are members of a data mirroring set (e.g., forming a RAID-1 mirroring set), each of the disks may be disk partitions within a single physical disk drive. Alternatively, the disks may be disk partitions spanned across a plurality of physical disk drives. Hence, the use of the term “disk” or “disk partition” herein may be interchangeable.

Furthermore, the usage of the term “disk” herein is intended to refer to any collection of data, whether stored in physical disk drive or logically accessible through a link (such as network connected drives, or some other physical media that may or may not be a drive such as flash connected to a host computer via Open NAND Flash Interface (ONFI)). Thus, the data mirroring is intended to include any form of data replication, and the ability to break and restore the mirror. Moreover, a disk is intended to be any collection of data that appears as a disk drive to hardware (e.g., a flash based solid state drive), or may be something that emulates a drive in software (such as flash on ONFI with a driver that emulates a drive).

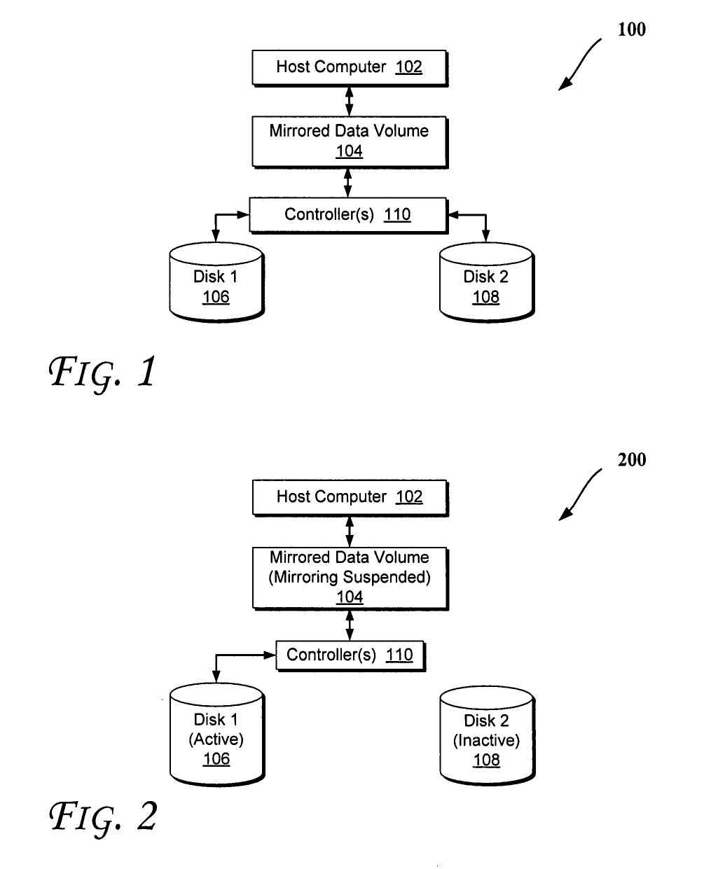

More particularly, FIG. 1 illustrates a block diagram of a disk mirroring system 100, according to one embodiment. The system 100 may include a host computer 102, a mirrored data volume 104, and one or more disks 106 and 108. In one embodiment, disks 106 and 108 may form a disk mirroring set (e.g., corresponding to a RAID-1 set) to store data read or written by the host computer 102. More than two disks may be utilized in some embodiments to form a data mirroring set.

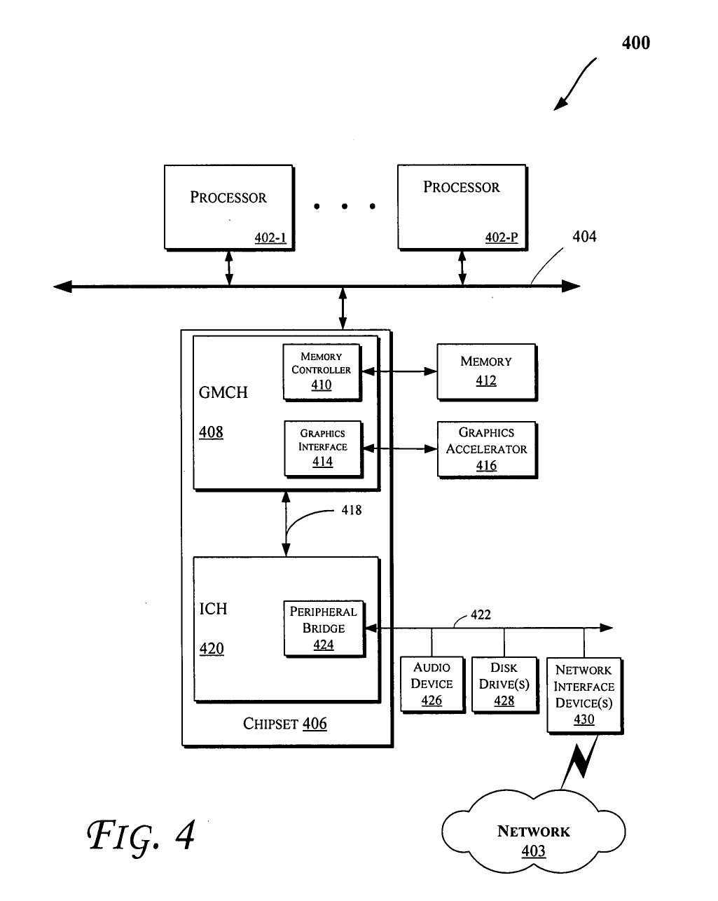

As shown in FIG. 1, the host computer 102 may access the disks 106 and/or 108 through the mirrored data volume 104. In one embodiment, the mirrored data volume 104 may be a logical representation of the disks 106 and 108 to the host computer 102. Furthermore, during normal mirroring operations, the disks 106 and 108 may store identical (mirrored) data. As will be further discussed with reference to FIG. 4, the disks 106 and 108 may communicate with the host computer 102 via the same or different communication protocols. Further, each of the disks 106 and 108 may be an Integrated Drive Electronics (IDE) disk, enhanced IDE (EIDE) disk, Small Computer System Interface (SCSI) disk, Serial Advanced Technology Attachment (SATA) disk, universal serial bus (USB) disk, Fibre Channel disk, Serial Attached SCSI (SAS) disk, Internet SCSI (iSCSI), etc. Also, the disks 106 and 108 may communicate with the host computer 102 via the same or different disk controllers 110 (complying with the aforementioned configurations, for example).

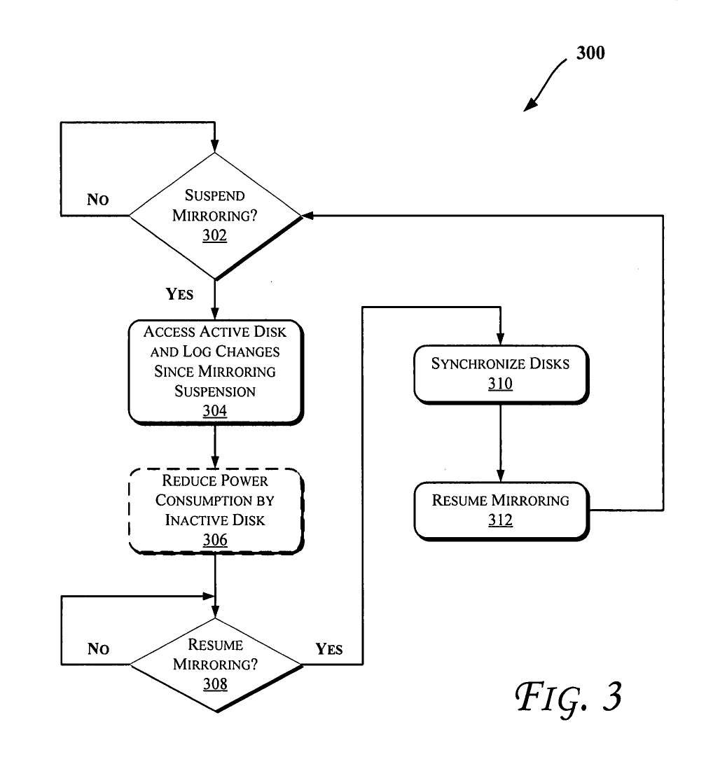

FIG. 2 illustrates a block diagram of a disk mirroring system 200 after one disk of the mirrored volume is inactivated, according to an embodiment. FIG. 3 illustrates a flow diagram of a method 300 for operating automated intermittent data mirroring volumes, according to an embodiment. In some embodiments, one or more of the components discussed with reference to FIGS. 1-2 and/or 4 may be utilized to perform one or more of the operations discussed with reference to method 300.

Referring to FIGS. 1 through 3, at an operation 302, it may be determined whether data mirroring has been suspended. In some embodiments, data mirroring may be suspended (e.g., by one of the disk controllers 110) in response to occurrence of an event. The event may be a predefined event or a scheduled event. For example, an end-user or a computer administrator may schedule mirroring suspensions and/or resumptions as will be further discussed herein.

At an operation 304, the active disk (e.g., disk 106 of FIG. 2) may be accessed (e.g., by the host computer 102). To reduce power consumption, the inactive disk may be optionally turned off, put into a sleep mode (or reduced power consumption mode), or decoupled from system at an operation 306. At an operation 308, it may be determined whether mirroring is to be resumed (e.g., based on occurrence of an event that may be predefined and/or scheduled such as discussed with reference to operation 302). Alternatively, the inactive disk may be mounted for access by the host computer 102 as a separate volume (e.g., while the original mirrored volume 104 may continue to operate by accessing the active disk 106). If mirroring is to be resumed, an operation 310 may synchronize the data stored in the active disk 106 and inactive disk 108. In one embodiment, after mirroring is suspended, a log may be maintained of changes to the active disk, e.g., to allow for a more efficient and/or quicker synchronization at operation 310. If the inactive disk is mounted as a new volume, a log of changes to the new volume may also be maintained for synchronization at operation 310. Once the disks are synchronized, mirroring may be resumed at an operation 312.

Accordingly, in one embodiment, there may be a mirrored volume (such as a RAID-1 volume, including for example volume 104 discussed with reference to FIGS. 1-3) that may be broken and re-synchronized per some schedule specified by a user. In an embodiment, the user may define a schedule via the mirroring product's user interface (which may cause configuration of one or more disk controllers 110). The schedule may be saved with the rest of the mirroring volume's meta-data. In an embodiment, the mirrored volume may normally run with its mirrors broken, e.g., where one disk is active the other is asleep or inactive but stores the exact same data as the active disk did at the time of the last re-synchronization or when the mirror was last broken. Furthermore, the schedule may specify when the mirrors are to be re-synchronized and re-broken, and the direction of the re-synchronization copy.

In one embodiment, in what may be referred to as a back-up with instant restore model, the user may schedule a periodic (e.g., daily, weekly, monthly, etc) re-synchronization from the active disk to the inactive disk, e.g., during a period of usual low activity. Then instead of running with data mirroring, the AIM volume may effectively be running without data mirroring protection but instead performing a periodic scheduled online image back-up with instant restore capabilities. This usage model may use less power as it uses fewer disk drives except during the scheduled re-synchronization copy. Unlike RAID-1, such an embodiment may save an image copy of old data for rollback capabilities, e.g., in case a virus or worm is introduced or a file is accidentally deleted or the operating system is mis-configured or damaged. For example, if the first disk fails, then the mirrored volume would (e.g., re-activate in one embodiment and) start to run off the second disk. Thus, the instant restore may occur (albeit to the point when the last synchronization was done, so losing all new data since the last synch). If the first disk is fine but its file system is damaged or infected, then the user may order a rollback by synchronizing the data from the second disk back to the first disk. Moreover, if the first disk is fine but a file is accidentally deleted, then the user may mount the second disk and copy the file back to the first disk, thus performing a file selective restore.

In another embodiment, e.g. in a public computer model, the public computer would use the AIM volume as its boot disk. The administrator would have the volume mirrored constantly while the computer is configured to a desired fresh state. Then the administrator would schedule a periodic (e.g., nightly, etc.) re-synchronization from the inactive disk to the active disk, for example. The computer would run all day being subjected to public use with public write permission to the volume's active disk. But, at each re-synchronization, an image rollback to the desired fresh state may be done by a re-synchronization copy from the inactive disk to the active disk.

In yet another embodiment, e.g., in the mobile platform model, the mirrored volume may use the event driven mirroring. For example, a mobile computing device (such as a personal digital assistant, a notebook computer, a smart phone, etc.) would have an AIM volume with both disk drives in the mobile platform. The AIM volume may be configured to break mirroring whenever the mobile device is drawing battery (DC) power and re-synchronize and continue mirroring whenever the device is drawing wall outlet (AC) power. This strategy would save battery power by running one disk whenever drawing battery power but returning to data mirroring, running both disks, whenever drawing outlet power.

Moreover, the host computer 102 discussed with reference to FIGS. 1-3 may include various components such as those discussed with reference to FIG. 4. Also, disks 106 and 108 may communicate with the host computer 102 through one or more disk controllers 110 that may be present (e.g., in the form of logic) in one or more of the components discussed with reference to FIG. 4, such as the chipset 406 (or one of its components such as items 408, 420, and/or 424 shown in FIG. 4), etc. More particularly, FIG. 4 illustrates a block diagram of a computing system 400 in accordance with an embodiment of the invention. The computing system 400 may include one or more central processing unit(s) (CPUs) or processors 402-1 through 402-P (which may be referred to herein as “processors 402” or “processor 402”). The processors 402 may communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, the operations discussed with reference to FIGS. 1A-3 may be performed by one or more components of the system 400.

A chipset 406 may also communicate with the interconnection network 404. The chipset 406 may include a graphics memory control hub (GMCH) 408. The GMCH 408 may include a memory controller 410 that communicates with a memory 412. The memory 412 may store data, including sequences of instructions that are executed by the processor 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with a graphics accelerator 416. In one embodiment of the invention, the graphics interface 414 may communicate with the graphics accelerator 416 via an accelerated graphics port (AGP). In an embodiment of the invention, a display (such as a flat panel display, a cathode ray tube (CRT), a projection screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the processor 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and one or more network interface device(s) 430 (which is in communication with the computer network 403). Other devices may communicate via the bus 422. Also, various components (such as the network interface device 430) may communicate with the GMCH 408 in some embodiments of the invention. In addition, the processor 402 and the GMCH 408 may be combined to form a single chip. Furthermore, the graphics accelerator 416 may be included within the GMCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-4, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed with respect to FIGS. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a disk controller to suspend data mirroring by a data mirroring set in response to occurrence of a first event,
wherein the data mirroring set comprises a first disk and a second disk coupled to the disk controller and the disk controller is to discontinue access to the second disk in response to occurrence of the first event while maintaining access to the first disk.

2. The apparatus of claim 1, wherein the first event corresponds to one or more of: a scheduled suspension event, a predefined event, a periodic event, or an event corresponding to a source of power provided to a host computer coupled to the disk controller.

3. The apparatus of claim 1, wherein the controller is to resume data mirroring by the data mirroring set in response to occurrence of a second event.

4. The apparatus of claim 3, wherein the second event corresponds to one or more of: a scheduled resumption event, a predefined event, a periodic event, or an event corresponding to a source of power provided to a host computer coupled to the disk controller.

5. The apparatus of claim 1, further comprising a host computer to access the first or second disks through the disk controller.

6. The apparatus of claim 1, wherein the disk controller comprises a plurality of disk controllers, wherein a first disk controller is to couple the first disk to a host computer and a second disk controller is to couple the second disk to the host computer.

7. The apparatus of claim 6, wherein the second disk is accessible by the host computer at the same time as the first disk.

8. The apparatus of claim 1, wherein at least one or more of the first or second disks comprise an Integrated Drive Electronics (IDE) disk, enhanced IDE (EIDE) disk, Small Computer System Interface (SCSI) disk, Fibre Channel disk, Serial Attached SCSI (SAS) disk, universal serial bus (USB) disk, Internet SCSI (iSCSI), or Serial Advanced Technology Attachment (SATA) disk.

9. The apparatus of claim 1, wherein the first disk corresponds to a first disk partition and the second disk corresponds to a second disk partition.

10. The apparatus of claim 1, further comprising logic to suspend or resume the data mirroring.

11. A method comprising:
suspending data mirroring by a data mirroring set in response to occurrence of a first event, wherein the data mirroring set comprises a first disk and a second disk; and
discontinuing access to the second disk in response to occurrence of the first event, while maintaining access to the first disk.

12. The method of claim 11, further comprising resuming the data mirroring in response to occurrence of a second event.

13. The method of claim 12, further comprising synchronizing the first disk and the second disk prior to resuming the data mirroring.

14. The method of claim 11, further comprising reducing power consumption of the second disk in response to occurrence of the first event.

15. The method of claim 11, further comprising detecting occurrence of the first event based on one or more of: a scheduled suspension event, a predefined event, a periodic event, or an event corresponding to a source of power provided to a host computer coupled to the first disk or second disk.
